(19) United States
(12) Patent Application Publication
(10) Pub. No.: US 2010/0055570 A1
(43) Pub. Date: Mar. 4, 2010

(54) BIOBATTERY WITH NANOCRYSTALLINE MATERIAL ANODE

(75) Inventor: Rodolfo Rodriguez, Mira Loma, CA (US)

Correspondence Address: PACESETTER, INC., 15900 VALLEY VIEW COURT, SYLMAR, CA, 91392-9221, US

(73) Assignee: PACESETTER, INC., Sylmar, CA (US)

(21) Appl. No.: 12/198,332

(22) Filed: Aug. 26, 2008

(51) Int. Cl. H01M 4/46; H01M 4/08

(52) U.S. Cl. 429/231.6; 29/623.1; 429/246

(57) ABSTRACT

A bioelectric battery used to power an implantable device comprises an anode electrode and a cathode electrode separated by an insulating member. The anode is formed from a nanocrystalline or ultra fine grain sized magnesium alloy. The magnesium alloy can be formed by subjecting a starting magnesium alloy to one or more plastic deformation treatments to reduce grain size and improve uniform material distribution, thereby reducing corrosion loss and improving service life.

### CROSS REFERENCE TO RELATED APPLICATIONS

This application is related to copending U.S. patent application Ser. No. 11/737,307, filed Apr. 19, 2007, titled “Bioelectric Battery for Implantable Device Applications.”

### FIELD OF THE INVENTION

This invention relates to power sources for implantable device applications and, more particularly, to an improved alloy material used for forming bioelectric batteries or biogalvanic cells.

### BACKGROUND

Space is a critical design element in implantable devices. In many implantable device applications, the power source occupies a large volume of the overall implantable device. Currently, many implantable devices utilize lithium batteries disposed within the implantable device as a power source. In order to minimize the size of the implantable device, it is desirable to use a power source having the greatest possible energy density. It is also desirable to utilize a power source having excellent longevity characteristics.

### BRIEF SUMMARY OF THE INVENTION

Disclosed is a power source for an implantable device application and more particularly a bioelectric battery or biogalvanic cell for use as a power source for an implantable device.

In one embodiment, the implantable bioelectric battery comprises an anode electrode, a cathode electrode and an insulating member separating the anode electrode and the cathode electrode, wherein the insulating member comprises a tube having a first end and a second end and wherein the anode electrode is inserted into the first end of the tube and the cathode electrode surrounds the tube such that the tube provides a support for the cathode electrode. The implantable bioelectric battery may further comprise a membrane surrounding the cathode electrode to reduce tissue encapsulation.

In another embodiment, the implantable bioelectric battery comprises an anode electrode, a cathode electrode surrounding the anode electrode, a permeable membrane encapsulating the cathode electrode, an electrolyte disposed within the permeable membrane, and a mesh surrounding the permeable membrane.

In a third embodiment, the implantable bioelectric battery is integrated with a pacemaker or other device such that the pacemaker or other device also acts as the cathode electrode. For example, the can of a pacemaker may be used as the cathode electrode and the anode electrode may be attached to the can of the pacemaker by an insulative adhesive.

It is desired that the material used to form the anode comprises a magnesium alloy and, more specifically, a nanocrystalline or ultra fine grain sized magnesium alloy that has been developed in a manner that provides a highly homogeneous material microstructure.

### BRIEF DESCRIPTION OF THE DRAWINGS

These and other features and advantages of the present invention will be appreciated as the same becomes better understood by reference to the following detailed description when considered in connection with the accompanying drawings wherein:

FIG. 1 is a side view of an example bioelectric battery according to a first embodiment;

FIG. 2 is a cross-sectional side view of an example bioelectric battery according to a first embodiment;

FIG. 3 is schematic view of an example bioelectric battery according to a first embodiment connected to an example medical device;

FIG. 4 is a cross-sectional view of an example bioelectric battery according to a second embodiment;

FIG. 5 is a cross-sectional side view of an example bioelectric battery according to a third embodiment;

FIGS. 6A and 6B are photomicrographs illustrating the material microstructure of a known magnesium alloys used for making a bioelectric batters; and

FIG. 7 is a photomicrograph illustrating the material microstructure of an example nanocrystalline or ultra fine grain sized magnesium alloy used to make example bioelectric batteries according to principles of the invention.

### DETAILED DESCRIPTION OF THE INVENTION

Disclosed herein is a bioelectric battery for implantable device applications. The bioelectric battery disclosed herein has the advantages of small size, low cost and long lifetime and can be utilized as a low power source for implanted devices. For example, the bioelectric batteries disclosed herein may provide power to an implanted device on the order of 100 μW.

Bioelectric batteries, also known as biogalvanic cells, are implanted in the body and rely on oxygen in internal body fluids for creating a voltage between an anode electrode and a cathode electrode. Oxygen in the body fluids reacts with the anode and consumes the anode, thereby creating an electric potential between the anode and cathode electrodes. Oxygen is present in the body in plentiful supply so the lifetime of the battery is limited only by the amount of anode material.

FIGS. 1 to 3 illustrate a first embodiment of a bioelectric battery 100. The bioelectric battery 100 comprises a cathode electrode 102 and an anode electrode 104 that is built into a single unit. The cathode 102 and anode 104 are separated by an insulating member 106. The insulating member 106 is a dielectric material that can be formed from a variety of material including but not limited to silicone, polytetrafluoroethylene, or other types of dielectric polymers. The insulating member 106 may be configured as called for by the particular bioelectric battery construction, and in an example embodiment is provided in the shape of a cylindrical tube.

The anode 104 can also be configured as called for by the particular bioelectric battery construction, and in an example embodiment is cylindrical and is inserted into a first end of the insulating member 106. The cathode 102 may be provided in the form of a wire disposed along an outside surface of the insulting member. In an example embodiment, the cathode is coiled around the insulating member 106.

Materials useful for forming the anode 104 and the cathode 102 include those that do not exhibit toxicity to the body of the organism in which they are implanted. The anode 104 is a reactive consumable metal that is consumed during the operation of the bioelectric battery and released into the body. Therefore, the material selected to form the anode is preferably one that is normally present in the body, and is of a size or quantity such that when released into the body does not increase the levels of the material beyond a normally recommended level. The material used to form the anode 104 should also be capable of generating a high voltage with oxygen. In an example embodiment, such material should be capable of generating a voltage in the range of from about 0.9 to 3.2, depending on the particular end use application.

Materials useful for forming the anode 104 may include, but are not limited to, magnesium alloys. Magnesium alloys include magnesium along with aluminum, zinc, manganese, silver, copper, nickel, zirconium and/or rare earth elements, such as neodymium, gadolinium, and yttrium. Suitable magnesium alloys can include, without limitation, one having the product name AZ61A supplied by Metal Mart International or AZ91E, EL21, or one having the product name WE43 supplied by Magnesium Elektron.

It has been discovered that such conventionally available magnesium alloys tend to have impurities, defects, grain boundaries and segregation of the various alloying additions. The presence of such elements or imperfections can create areas of preferential corrosion attack that is undesired as it can lead to excess mass loses not associated with the current draw during battery or cell operation. The mass loss caused by preferential corrosion attack due to the in-homogeneity of the conventional magnesium alloy material microstructure can compromise biobattery longevity.

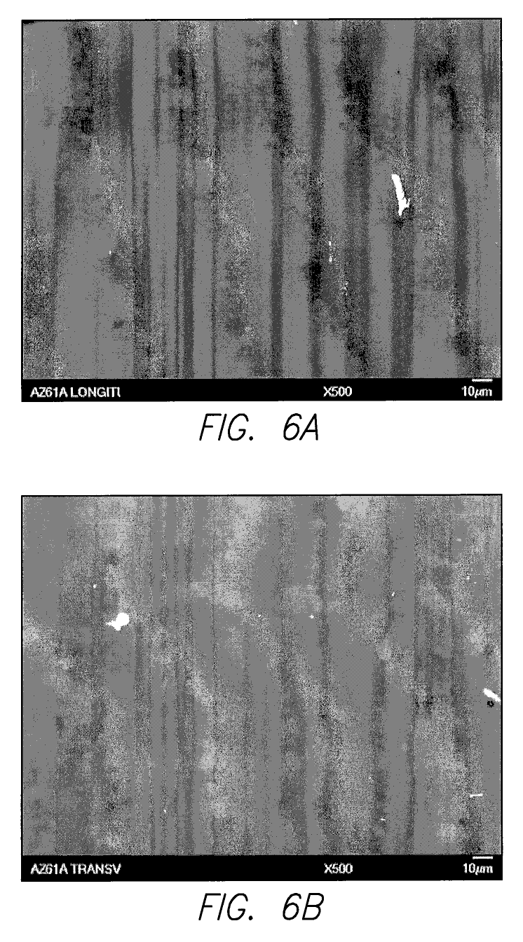

FIGS. 6A and 6B illustrate backscattered electron images showing the material microstructure of a conventional magnesium alloy material, i.e., AZ61A. FIG. 6A illustrates the material microstructure in a longitudinal direction, and FIG. 6B illustrates the material microstructure in a transverse direction. The images illustrate the presence of large impurities as well as a large distribution in grain size between the transverse and longitudinal directions. It is these impurities and the distribution in grain size that can lead to non-uniform corrosion of the magnesium alloy material. The grain size of the above-noted magnesium alloy is on the order of a few hundred microns.

It is, therefore, desired that the magnesium alloy used to form the anode or biobatteries be one that is characterized as having a high degree of homogeneity and having a relatively small or fine grain size. This objective can be achieved by using a magnesium alloy having a material microstructure characterized by an average grain size in the range from about 50 to 2500 nanometers and having a substantially uniform alloy distribution. This can be achieved, for example, by starting with a magnesium alloy having these material characteristics.

Alternatively, it has been discovered that such desired magnesium alloy material microstructure characteristics can be achieved by subjecting available magnesium alloys, such as those described above, to certain treatment processes. In an example embodiment, it has been discovered that such improvements in the starting magnesium alloy microstructure can be achieved by subjecting such starting magnesium alloy materials to one or more specific pressing treatments that cause the magnesium alloy to undergo plastic deformation.

In an example embodiment, the above-described starting magnesium alloy material is subjected to equal channel angular pressing (ECAP) for the purpose of refining the material microstructure of the starting magnesium alloy. During ECAP, the magnesium alloy material undergoes severe plastic deformation by simple shear at ideal, frictionless conditions. During ECAP, strains up to about 100 percent are introduced into the magnesium alloy material without fracturing.

The magnesium alloy material may be subjected to one or more ECAP processes depending on the particular starting and desired ending magnesium material microstructure. In an example embodiment, the magnesium alloy material is subjected to a number of ECAP passes, and deformation of the magnesium alloy material accumulates with each successive pass. The accumulation of deformation eventually leads to a material microstructure that is more uniform and that has a finer grain size than the starting magnesium alloy material.

While use of ECAP has been disclosed, it is to be understood that other treatment process capable of reducing the grain size of the magnesium alloy and improving the uniform distribution of material microstructure can be used and are within the scope of this invention. These processes include those that subject the magnesium material to shear and cause it to undergo plastic deformation.

The improvement in magnesium alloy uniformity and reduction in grain size is generally expected to increase the corrosion rate of the material because of the increase in grain boundary area, an area of high defect density, but this result is not observed when the starting magnesium alloy material is one of those described above, e.g., the AZ61A magnesium alloy material.

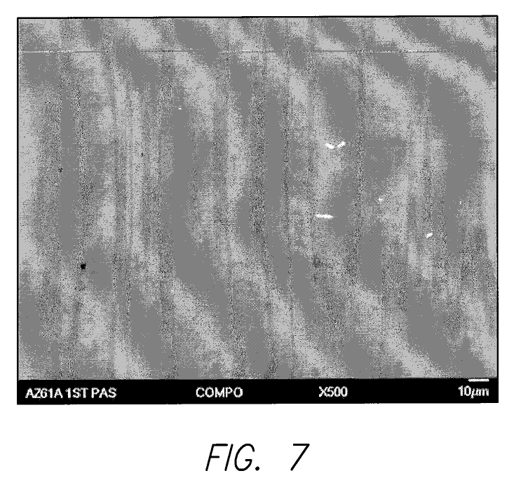

FIG. 7 is a photomicrograph illustrating the material microstructure taken in the longitudinal direction of the starting magnesium alloy material AZ61A after just one ECAP treatment. This image illustrates the substantial reduction in grain size just after one pass when compared to the grain size of the starting AZ61A magnesium alloy material as illustrated in FIG. 6A. This photomicrograph also illustrates the reduction in the size of impurities, which have been broken down by the high shear stresses generated during the ECAP process.

The magnesium alloy material subjected to ECAP treatment was evaluated for corrosion resistance. It was discovered that the ECAP treated magnesium alloy displayed a corrosion rate of approximately 5.5 mg/day within the first three days of operation, in contrast to 16 mg/day within the first three days for the starting magnesium alloy material, e.g., the AZ61A material, representing a 65 percent improvement in corrosion resistance. The corrosion rate for the ECAP treated magnesium alloy displayed a corrosion rate of approximately 8.5 mg/day after 10 days when contrasted to 36 to 49 mg/day for the non-ECAP treated magnesium alloy, representing a 76 to 83 percent improvement in corrosion resistance.

Useful materials for forming the cathode 102 are non-consumable metals including, without limitation, platinum or titanium. The cathode 102 may be in the form of, including, without limitation, a metal foil or wire. The cathode 102 may also have a coating that acts as a catalyst for the reaction at cathode 102. A coating increases the surface area of cathode 102, thereby resulting in a faster reaction and increased voltage generation. The coating may be formed from materials including, without limitation, platinum black, iridium oxide (IrO₂), ruthenium oxide (RuO₂) or an IrO₂/RuO₂ mixture. For example, the cathode 102 may be a platinum black coated platinum wire or an iridium oxide coated titanium wire. The coating may be applied using conventional methods including, without limitation, electrochemical deposition, thermal decomposition or sputtering.

The electrolyte for the bioelectric battery 100 may be a body fluid including, without limitation, blood. When the electrolyte is a body fluid, the body fluid directly contacts the cathode 102 and the anode 104, such that oxygen dissolved in the body fluid is absorbed onto a surface of the cathode 102 and reacts with anode 104.

A first end of a lead 108, such as pacing lead with an IS-1 connection, extends from a second end of the insulating member 106 and provides a current flow between the anode 104 and the cathode 102 and provides power to a load 312, including, without limitation, an implantable medical device, connected to a second end of lead 108. Exemplary implantable medical devices include, without limitation, pacemakers, monitors or implantable cardioverter defibrillators (ICDs). The bioelectric battery 100 may be sufficient to power an implantable monitor, intrapericardial pacemaker, intraventricular pacemaker or standard pacemaker; or the background operations of an ICD.

In one embodiment, a cylinder 104 formed from the desired magnesium alloy material is inserted into a silicone tubing 106 and a platinum wire 102 is coiled around the silicone tubing. The magnesium alloy cylinder 104 and platinum wire 102 are connected to pacing leads 108 to act as the anode electrode and cathode electrode, respectively, of the bioelectric battery 100. Magnesium and oxygen in the body fluids are slowly consumed as a current is generated. The platinum wire may be coated, such as with a platinum black coating. Alternatively, a titanium wire may be used as the cathode electrode. The titanium wire may be coated, such as with a platinum black, iridium oxide or ruthenium oxide coating.

The bioelectric battery 100 may be implanted anywhere in the body of an organism including, without limitation, subcutaneously in the neck, the pectoral cavity, the superior vena cava, the intrapericardial space or the peritoneal cavity. The bioelectric battery 100 is implanted in tissue or blood vessels such that cathode 102 and anode 104 are in direct contact with body fluids. Therefore, the body fluids act as the electrolyte for bioelectric battery 100.

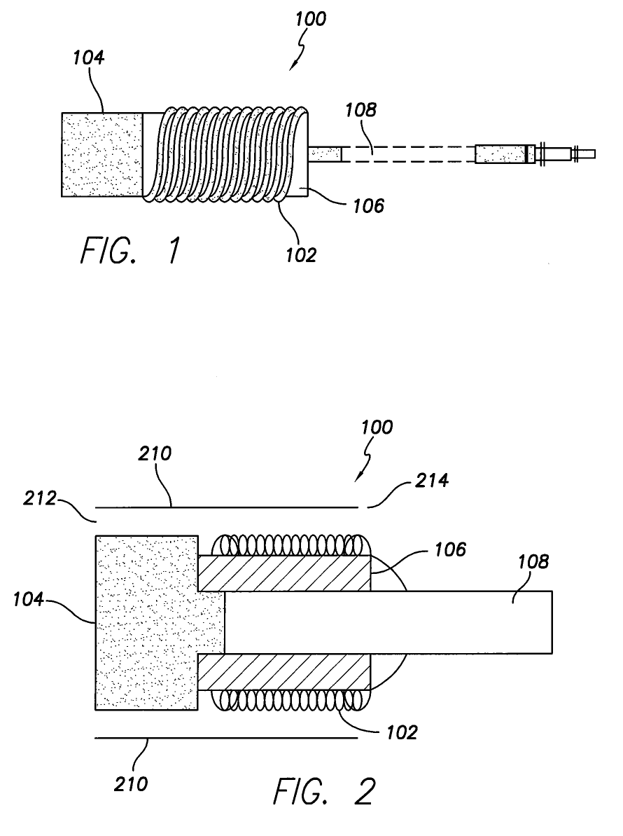

As shown in FIG. 2, the bioelectric battery 100 may have a membrane 210 surrounding the anode 104 and the cathode 102. The membrane 210 is wrapped around the anode 104 and cathode 102, or may be wrapped around only the cathode 102. The wrapped membrane 210 has a first open end 212 and a second open end 214 through which body fluid may flow such that body fluid contacts the anode 104 and cathode 102. Implanted bioelectric batteries may have problems with tissue growing over the battery, a phenomenon known as tissue encapsulation. Tissue encapsulation occurs when body tissue grows over an electrode, reducing the amount of oxygen contacting the surface of the electrode and therefore, decreasing the efficiency of the battery. It is desired that the membrane 210 be made of a material that minimizes tissue encapsulation including, without limitation, silicone. The material used to form the membrane 210 is also porous and permeable to oxygen.

The bioelectric battery 100 may have different sizes depending upon where it will be implanted in the body. For example, a battery that is 10 mm in diameter and 50 mm in length can be utilized when the battery is to be implanted in the intrapericardial space or abdomen. Also for example, a battery that is 5 mm in diameter and 55 mm in length can be utilized when the battery is to be implanted in smaller areas such as the superior vena cava (SVC). These dimensions are merely exemplary and bioelectric battery 100 is not limited to these dimensions. Other exemplary dimensions include, but are not limited to, 5 mm in diameter and 48 mm in length; 5 mm in diameter and 50 mm in length; or 10 mm in diameter and 43 mm in length.

While FIGS. 1 to 3 illustrate the bioelectric battery 100 as a single unit, the anode 104 and cathode 102 may be separated. For example, the anode 104 may be implanted a predetermined distance from the cathode 102 that allows for an electric potential to exist between the cathode 102 and anode 104 utilizing body fluid as the electrolyte. In such an instance, the anode 104 may be of any conventional shape including, without limitation, a cylinder or a disc and the cathode 102 may be part of the load. The load, which is connected to the anode 104 and cathode 102, includes, without limitation, an implantable medical device. Exemplary implantable medical devices include, without limitation, pacemakers, monitors, or implantable cardioverter defibrillators (ICDs).

When the load is an ICD, the superior vena cava (SVC) electrode of a defibrillator lead acts as the cathode 102. The SVC electrode may be any material meeting the requirements for the cathode described above including platinum. The SVC electrode may also have a coating including, without limitation, platinum black, iridium oxide (IrO₂), ruthenium oxide (RuO₂), or an IrO₂/RuO₂ mixture.

In one embodiment, the SVC electrode of a defibrillator lead is coated, such as with a platinum black coating, and is shared as the cathode electrode. A magnesium electrode is placed in the subcutaneous tissue of a pectoral cavity. The two electrodes are separated, but both are connected to the medical device through the lead.

Such bioelectric batteries reduce the size and number of components which need to be implanted.

FIG. 4 illustrates a second embodiment of the bioelectric battery 400. In this embodiment, the bioelectric battery 400 is an encapsulated battery having an anode electrode 402 surrounded by a cathode electrode 404 with an electrolyte 406 therebetween.

The materials useful for forming the anode 402 and cathode 404 are chosen that do not exhibit toxicity to the body of the organism in which they are implanted. Anode 402 will be a reactive consumable metal that is consumed during the operation of the bioelectric battery and released into the body. Therefore it should be a material that is normally present in the body and of a size that when released into the body does not increase the levels of the material beyond a normally recommended level. The material for the anode 402 should also exhibit good corrosion resistance. Anode corrosion, caused by substances in the body fluids corroding the anode material, shortens the life of the bioelectric battery. The anode material 104 should also generate a high voltage with oxygen.

The material useful for forming the anode 402 includes the same nanocrystalline and ultra-fine grain sized magnesium alloy materials described above. Materials useful for forming the cathode 404 can be selected from the same types of materials described above, e.g., non-consumable metals including, without limitation, platinum or titanium.

The cathode 404 may be in the form of, including, without limitation, a foil or wire. Cathode 404 may have a coating that will act as a catalyst for its reaction by increasing the surface area of cathode 102 and thereby resulting in a faster reaction and increased voltage generation. The coating may include, without limitation, platinum black, iridium oxide (IrO₂), ruthenium oxide (RuO₂), or an IrO₂/RuO₂ mixture. The coating may be applied using conventional methods including, without limitation, electrochemical deposition, thermal decomposition or sputtering.

The electrolyte 406 is not body fluid and may be any other known conventional electrolyte that is less corrosive to the anode than body fluids in the form of a liquid or a gel. Examples include, but are not limited to, a gel or a solvent, e.g., isopropanol based solution containing a conductive component, such as sodium trifluoromethanesulfonate (CF₃SO₃Na) or sodium citrate dihydrate (Na₃C₆H₅O₇.2H₂O). There is no direct contact between the cathode 404 and the body fluid, as the cathode is encapsulated with a permeable membrane 408 to prevent direct contact with the body fluid. Therefore, the oxygen must diffuse through the permeable membrane 408 to reach the cathode 404 and anode 402.

A permeable membrane 408 surrounds the cathode 404. The permeable membrane 408 separates body fluids from the cathode 404 and anode 402, thereby preventing corrosion of the anode 402 from substances in the body fluids. The permeable membrane 408 is made from a porous polymeric material that allows oxygen in body fluids to diffuse through permeable membrane 408, but prevents other substances in the body fluid from passing through the permeable membrane 408. Suitable materials for forming the permeable membrane 408 include silicone and polytetrafluoroethylene (PTFE).

A mesh material 410 may surround the permeable membrane 408. The mesh 410 provides strength to the bioelectric battery 400, provides protection, and further reduces tissue encapsulation. Suitable materials for the mesh 410 include, without limitation, stainless steel, titanium or other biocompatible material.

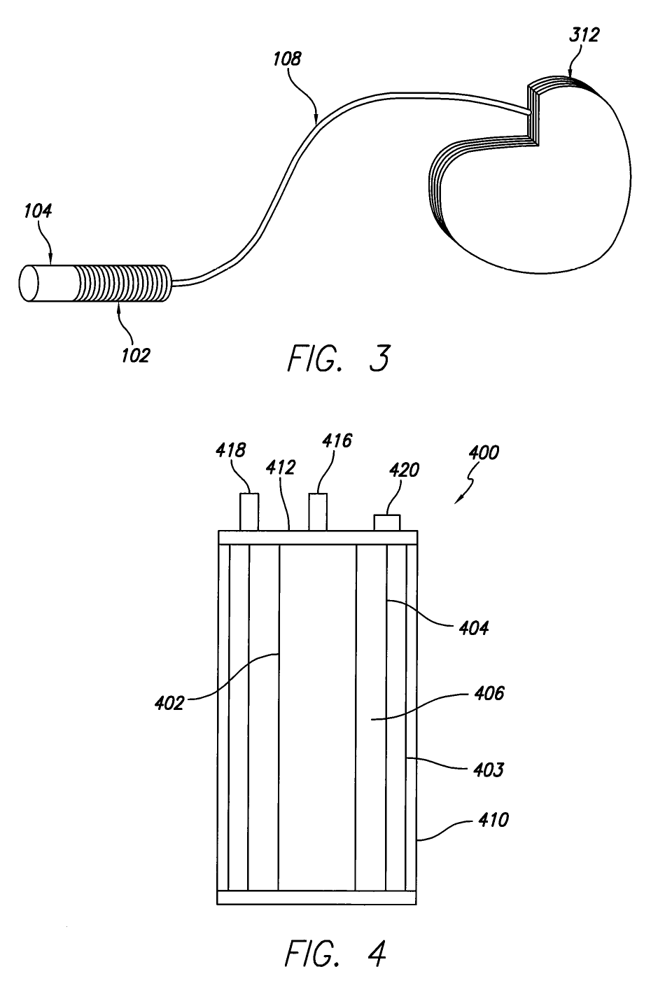

The bioelectric battery 400 also includes a top plate 412 and a bottom plate 414 joined to the permeable membrane 408 to form an encapsulated bioelectric battery. The top plate 412 has a connection point 416 for connecting the anode 402 to a load, a connection point 418 for connecting the cathode 404 to a load, and an opening 420 for introducing the electrolyte into battery 400. A load (not shown) is connected in parallel to the anode 402 and cathode 404. The bioelectric battery 400 provides power to the load. The load includes, without limitation, an implantable medical device (not shown) and is connected in a similar fashion as illustrated in FIG. 3 for the bioelectric battery of the first embodiment. Exemplary implantable medical devices include, without limitation, pacemakers, monitors or implantable cardioverter defibrillators (ICDs). In the case of an ICD, the bioelectric battery 400 provides power to the background operations.

In one embodiment, two electrodes are built in an encapsulated cell 400. A magnesium electrode 402 is placed in the center, and a titanium foil electrode 404 is placed around the magnesium electrode 402. In one embodiment, the electrode 402 acts as an anode material and the electrode 404 acts as a cathode electrode. The electrode 404 may include a support substrate and the electrode 404 is placed around electrode 402 such that an inside surface of the support substrate faces electrode 402. The support substrate may be a biocompatible, polymeric material and have openings along its length to allow the electrolyte 406 to contact electrode 404. In one embodiment, the electrode 404 may be a wire coiled around the support substrate. The titanium foil may be coated, such as with a platinum black, iridium oxide or ruthenium oxide coating. A porous polymer membrane is placed around the titanium foil cathode. Oxygen in the body fluid can pass through the permeable membrane into the cell. A stainless steel mesh is placed around the membrane. A conductive electrolyte that is less corrosive than the body fluid is filled in the cell. The anode corrosion problem is reduced, since the magnesium electrode is exposed to the selected electrolyte, instead of the body fluid. Additionally, since the cell is isolated, the electrodes do not touch the tissue, so there is no current passing through the surrounding tissue.

The bioelectric battery 400 is implanted in the body such that the permeable membrane 408 is in direct contact with body fluids. Oxygen in the body fluids diffuses through the permeable membrane 408 and into the bioelectric battery 400. A plurality of bioelectric batteries 400 can also be connected in series.

Such bioelectric batteries minimize tissue encapsulation and/or anode corrosion.

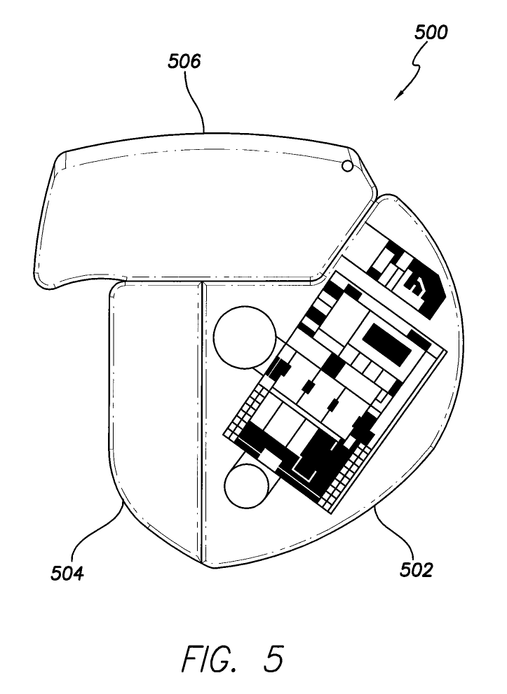

FIG. 5 illustrates a third embodiment of the bioelectric battery formed as a single unit with a pacemaker 500 or other device, wherein the housing acts as a cathode electrode. In this manner, the can 502 of the pacemaker 500 acts as the cathode electrode. The can 502 of the pacemaker 500 is titanium or other material that satisfies the desired properties for the cathode as described above. The can 502 may have a coating including, without limitation, platinum black, iridium oxide (IrO₂), ruthenium oxide (RuO₂), or an IrO₂/RuO₂ mixture. The coating may be applied using conventional methods including, without limitation, electrochemical deposition, thermal decomposition or sputtering.

An anode electrode 504 is insulated from but integrated with the can 502 of the pacemaker 500 as a single unit. The material for the anode 504 should not exhibit toxicity to the body of the organism in which it is implanted and should generate a high voltage with the oxygen. The anode 504 will be a reactive consumable metal that is consumed during the operation of the bioelectric battery and released into the body. Therefore it should be a material that is normally present in the body and of a size that when released into the body does not increase the levels of the material beyond a normally recommended level. The material for the anode 504 should also exhibit good corrosion resistance. The material for the anode 504 may include, but is not limited to, magnesium alloys. Magnesium alloy materials useful for forming the anode include those nanocrystalline and ultra fine grain sized magnesium alloys described above for the other embodiments.

The anode 504 may be attached to the pacemaker 500 through an insulating adhesive such as an epoxy material or the like. Alternatively, the anode 504 may be detached from the pacemaker 500. In an example embodiment, the distance between the anode and pacemaker is optimized to reduce impedance. A conventional header 506 is attached to the can 502 of the pacemaker 500 in order to connect to pacing leads.

The electrolyte for the bioelectric battery, wherein the can 502 acts as a cathode, may be a body fluid including, without limitation, blood. The body fluid directly contacts can 502 and anode 504, such that oxygen dissolved in the body fluid is absorbed onto a surface of can 102.

The volume of the anode 504 is smaller than a traditional lithium battery utilized to power a pacemaker, so the size of the pacemaker/battery combination is smaller than a conventional pacemaker having a traditional lithium battery.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for making an implantable bioelectric battery comprising the steps of:
forming an anode electrode from a starting magnesium material, wherein the starting magnesium material is treated to form a final magnesium material, wherein during the step of treating the average grain size of the starting magnesium material is reduced to a grain size of from about 50 to 2500 nanometers; and
placing a cathode electrode adjacent the anode electrode, wherein the anode electrode and cathode electrode are separated from one another by an insulating member.

2. The method of claim 1 wherein the magnesium material is an alloy, and wherein the starting magnesium material is treated by plastic deformation.

3. The method of claim 1 wherein the starting magnesium material is treated by equal channel angular pressing.

4. The method of claim 1 wherein the starting magnesium material is treated a number of times, and wherein the final magnesium material has a substantially uniform material microstructure.

5. The method of claim 1 wherein the cathode electrode and anode electrode are placed such that when the battery is implanted, both the anode and the cathode may be exposed directly to body fluid.

6. A method for making an implantable bioelectric battery comprising the steps of:
forming an anode electrode from a starting magnesium material, wherein the starting magnesium alloy material has a starting average grain size and is treated by plastic deformation to form a final magnesium material having a final average grain size that is less than the starting average grain size by at least an order or magnitude; and
placing a cathode electrode adjacent the anode electrode, wherein the anode electrode and cathode electrode are separated from one another by an insulating member.

7. The method of claim 6 wherein the final average grain size in the range of from about 50 to 2500 nanometers.

8. The method of claim 6 wherein the magnesium material is an alloy and is treated by equal channel angular pressing.

9. The method of claim 6 wherein the cathode electrode and anode electrode are placed such that when the battery is implanted, both the anode and the cathode may be exposed directly to body fluid.

10. An implantable power supply comprising:
a bioelectric battery for implantation into a living body, the battery including an anode electrode and a cathode electrode, and further including an insulating member separating the anode electrode from the cathode electrode;
wherein the anode electrode is formed from a magnesium material having an average grain size in the range of from about 50 to 2500 nanometers.

11. The battery of claim 10 wherein the magnesium material has a material microstructure that is substantially uniform.

12. The battery of claim 10 wherein the magnesium material is an alloy material.

13. The battery of claim 10 wherein the anode electrode has a substantially homogeneous material distribution.

14. The battery of claim 10 wherein the cathode electrode and anode electrode are arranged such that when the battery is implanted, both the anode and the cathode may be exposed directly to body fluid.
